(19) United States
(12) Patent Application Publication
(10) Pub. No.: US 2015/0373487 A1
(43) Pub. Date: Dec. 24, 2015

(54) LONG LIFE CONTAINER TRACKING DEVICE AND METHOD FOR DETECTING TAMPERING WITH THE TRACKING DEVICE

(71) Applicant: Hirschmann Car Communication Inc., Auburn Hills, MI (US)

(72) Inventors: Alan W. Miller, Milan, MI (US); Syed Bilal Ul Haq, Rochester Hills, MI (US); Frank Homann, Shelby Township, MI (US); Ioan Stan, Bloomfield Hills, MI (US); Troy Bartz, Lake Orion, MI (US)

(21) Appl. No.: 14/747,730

(22) Filed: Jun. 23, 2015

Related U.S. Application Data
(60) Provisional application No. 62/015,834, filed on Jun. 23, 2014.

(51) Int. Cl. H04W 4/02; H04B 1/40; G06Q 10/08

(52) U.S. Cl. CPC H04W 4/02; G06Q 10/0833; H04B 1/40; H04W 84/12

(57) ABSTRACT

A tracking device is provided having a normally open passive switch for detecting when the tracking device has been removed from a container on which it has been installed. The device includes a powered communication system and the normally open passive switch that is biased toward a closed position. The switch is maintained in the normally open condition via a magnet disposed near the switch. The magnet is disposed on the container and aligned with the switch. The switch includes a magnetically reactive element coupled thereto. When the tracking device is moved away from the container, the magnetic force on the switch will be reduced, and the bias in the switch will cause the switch to move to the closed position. Upon moving the switch to the closed position, the communications system will transmit a message that the device has been removed. When the switch is in the normally open state, the circuit on which the switch is disposed will not draw any power.

### CROSS-REFERENCE TO RELATED APPLICATIONS

This application claims the benefit of U.S. Provisional Application No. 62/015,834, filed Jun. 23, 2014, which is hereby incorporated by reference in its entirety.

### FIELD

The present invention relates generally to container tracking, and more particularly relates to detecting and tracking tampering attempts made on container tracking devices.

### BACKGROUND

A variety of different products are transported in shipping containers. Products are packed into the container by a shipper, and then the container doors are closed and secured with some type of lock. The locked container is then transported to a destination, where a recipient removes the lock and unloads the container.

It is often advantageous to the shipper if some form of monitoring can be carried out while the container is being transported. As one example, containers may become lost or stolen, and thus many shippers own more containers than they need since the location of some containers will be unknown. The ability to accurately track the current location of the container as it travels from the shipper to the recipient helps ensure high usage rate and prevent the container from becoming lost. The cargo in the container may also include relatively valuable products such as computers or other electronic devices, and accurate location information can be of great importance.

It is not cost-feasible to have a person watch a container at all times in order to provide security and/or monitoring. Accordingly, electronic systems have previously been developed to provide a degree of automated security and/or monitoring. Since the containers may be carried on ships, railcars or trucks, they may not have access to an external power source, and thus include a battery system. Unfortunately, many of these electronic tracking systems have a short life of less than 5 years, often due to a loss of power or degradation of the components, and/or existing systems require maintenance and battery recharging/replacement to extend the life of each system.

Before, during, or after shipment of the containers, it is possible that the containers may be opened without authorization. Containers include various devices for limiting unauthorized access, such as locking devices or the like, but a motivated party can still subvert these locking devices in some instances. If undetected, it can take a long time for a container handler to realize that the container has been opened, often not being detected until the container has reached its final destination and is being unloaded.

An unauthorized user may desire to subvert the functionality of a tracking system after the tracking system has been installed on the container by tampering with or removing the tracking system. By removing the tracking system, an unauthorized user could send the tracking device to a different location, or maintain it in a previous location, which could lead to incorrect reporting of a container's position. Instead of reporting the location of the container, the location of the removed tracking system would be reported. Improvements can be made to increase the reliability of tracking systems or detecting tampering with tracking systems.

### SUMMARY

The invention may include any of the following aspects in various combinations and may also include any other aspect described below in the written description or in the attached drawings.

In a first aspect, a tracking device is provided for tracking the location of a container, the container having a surface on which to mount the tracking device. In this aspect, the tracking device comprises a housing mounted to the container, the housing containing a communication system and a power system. The communication system identifies the location of the container and communicates the location. The power system for supplies power to the communication system. A switching device is connected to the housing for movement therewith. The switching device is electrically connected to the communication system in a circuit, the switching device operable between a closed state closing the circuit and an open state opening the circuit. The switching device has a normally open state. A first magnetically reactive element forms part of the switching device and moves to operate the switching device between the open state and the closed state. The first magnetically reactive element is biased to one of the open state and the closed state. A second magnetically reactive element is mounted to the container at a position spaced a predetermined distance from the first magnetically reactive element. One of the first and second magnetically reactive elements generates a magnetic field that induces a magnetic force on the first magnetically reactive element in opposition to the bias thereon. Movement of the housing relative to the container changes the position of the first magnetically reactive element relative to the second magnetically reactive element to vary the magnetic force and cause the first magnetically reactive element to move and operate the switching device to the closed state.

According to more detailed aspects, one of the first and second magnetically reactive elements is a magnet generating a magnetic field. The magnetic force provided by the magnet remains constant, and the received magnetic force only changes in response to the tracking device being moved. The device includes a housing having a bottom wall and a top wall, and the switching device is arranged within the housing and adjacent the bottom wall. The device includes at least one adhesive pad attached to an outer surface of the bottom wall. The at least one adhesive pad defines a recess. The recess has a height and a width, and the device further comprises magnet that provides the magnetic force that is received by the magnetically reactive element to counteract the biasing element, wherein the magnet has a height and width smaller than the recess. The magnet is attached to the device via an adhesive element disposed therebetween. The device includes a second adhesive element extending over the magnet, wherein the magnet is disposed between the adhesive element and the second adhesive element.

In another aspect, a method for detecting movement of a tracking device on a container is provided, the method comprising: providing the tracking device comprising a housing having a bottom wall, the housing containing a switching device mounted to the housing for movement therewith, the switching device electrically connected to a powered communication system, the switching device being in a normally open state, the switching device including a biasing element biasing a magnetically reactive element to a closed state, and a magnet releasably attached to the an external surface of the bottom wall of the tracking device, the magnet being positioned over the switching device to induce a magnetic force on the magnetically reactive element that counteracts the biasing element and keeps the switching device in the open state; attaching the tracking device to the container with the bottom wall against a surface of the container; attaching the magnet to the surface of the container such that, upon movement of the tracking device away from the surface of the container, the position of the magnet on the surface of the container is maintained; and switching the switching device to the closed position via the biasing element when the bottom wall is moved away from the surface of the container and the magnetic force of the magnetically reactive element is reduced.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a perspective of an embodiment of the container tracking device attached to a container, constructed in accordance with the teachings of the present invention;

FIG. 2 is a perspective view of the tracking device of FIG. 1;

FIG. 3 is an exploded perspective of the tracking device of FIG. 1;

FIG. 4 is a partial perspective view, cut away, of the tracking device of FIG. 1;

FIG. 5 is a partial perspective view of the tracking device of FIG. 1;

FIG. 6 is a partial perspective view, cut away, of the tracking device of FIG. 1;

FIG. 7 is a schematic of the tracking device of FIG. 1;

FIG. 8 is a schematic of the power system forming a part of the tracking device of FIG. 1;

FIG. 9 is a schematic of another embodiment of the power system forming a part of the tracking device of FIG. 1;

FIG. 10 is a perspective view of the tracking device attached to a door of the container;

FIG. 11 is a perspective view of the tracking device having a door open detect sensor, the tracking device installed near a rotatable door latching rod of the container;

FIG. 12 is a cross-sectional view of a magnet attached to the rod and aligned with the door open detect sensor;

FIG. 13 is a cross-sectional view of the magnet and the rod in a rotated position, with the magnet moved away from the door open detect sensor;

FIG. 14 is a schematic view of a switch being in a normally open state when the magnet is positioned near the switch;

FIG. 15 is a schematic view of the switch being closed due to a bias in the switch when the magnet is moved away from the switch;

FIG. 16 is a flow-chart illustrating the operation of the door open detect sensor;

FIG. 17 is an exploded perspective view of the tracking device having a tamper detect sensor and the door open detect sensor;

FIG. 18 is a schematic view of a switch being in a normally open state when the magnet is positioned near the switch;

FIG. 19 is a schematic view of the switch being closed due to a bias in the switch when the magnet is moved away from the switch;

FIG. 20 is a bottom view and accompanying cross-sectional view of the tracking device having a magnet disposed adjacent the tamper detect sensor and adhesive pads for installing the tracking device;

FIG. 21 is bottom view and accompanying cross-sectional view of the tracking device having an alternative arrangement of an adhesive pad for installing the tracking device;

FIG. 22 is a cross-sectional view showing the magnet attached to the tracking device prior to installing the tracking device;

FIG. 23 is a cross-sectional view of the tracking device being moved away from the magnet and the container;

FIG. 24 is a flow-chart illustrating the operation of the door open detect sensor.

### DETAILED DESCRIPTION

As discussed above, the present application is generally directed towards the tracking of containers, which as used herein includes all types of containers or receptacles for moving objects, including trailers, crates, pallets and related vehicles such as trucks, cargo vans, planes, ships, and all forms of shipping containers. It will be recognized by those skilled in the art that the tracking device may be attached and used with a wide variety of such containers and motive objects, especially larger containers hauled by trucks, trains and placed on boats, as well as stationary objects such as mounting or placing the tracking device in a remote area with no power, the device having a sensor to report a sensed parameter such as temperature, etc.

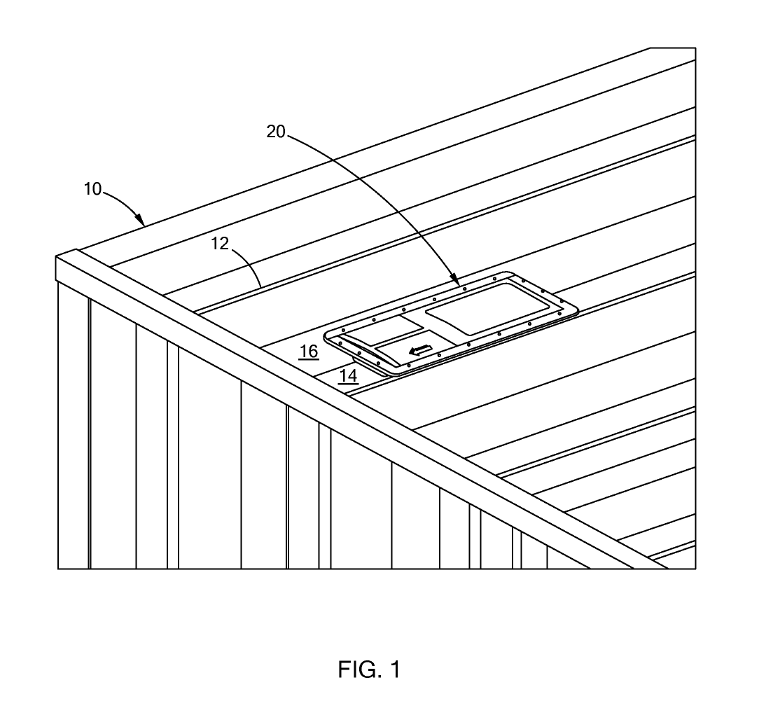

FIG. 1 depicts a container 10 having a tracking device 20 constructed in accordance to the teachings of the present invention. Through the combination of features described below, including noted improvements in power supply and management, the tracking device 20 exhibits a long life of 10 to 20 years or more without maintenance or service (including without connection to an external power source), which has not yet been accomplished by a tracking device in the industry.

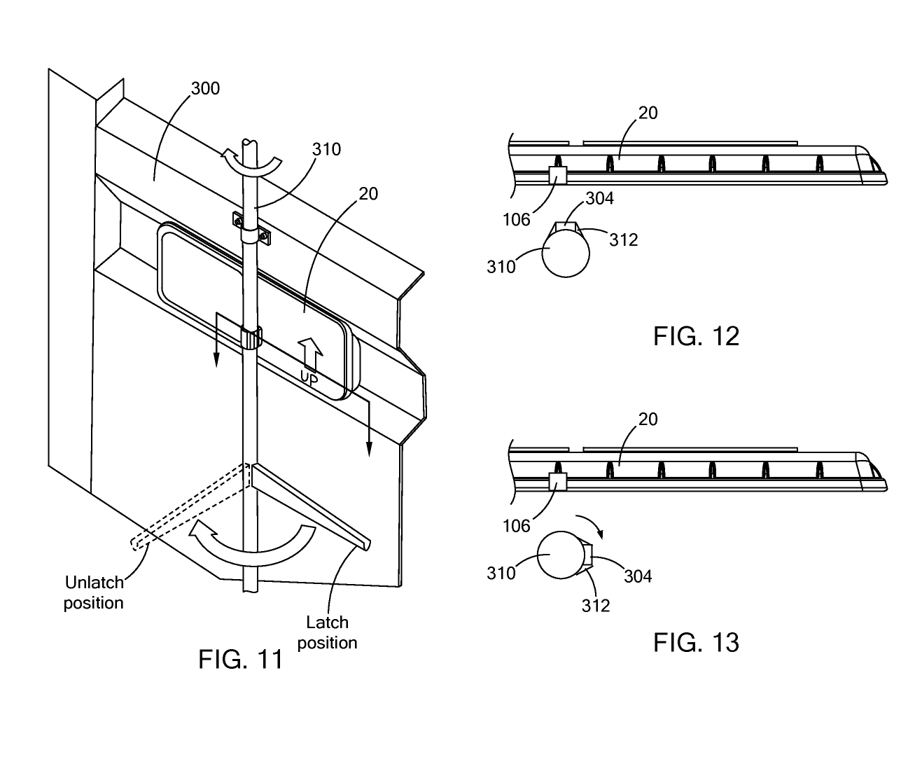

The container 10 generally includes a series of corrugations 12 defined by at least a bottom wall 14 connected between opposing sloped walls 16. The tracking device 20 is sized and shaped to fit within these corrugations 12 so as not significantly project from an outermost horizontal plane of the container 10, and therefore preferably has a height about 35 mm or less. Similarly, the device 20 can be mounted to a vertical plane of the container 10 within horizontally aligned corrugations 12, such as on a door panel of the container 10. As used herein, the bottom wall 14 can also refer to the vertical surface against which the device 20 is placed and fixed. A preferred construction of the device 20 has a lower surface width of about 70 mm or less, a length of about 350 mm, and a height of about 33 mm or less. Preferably, the contour of the sides and bottom surface of the device 20 matches the shape of the bottom wall 14 and sloped sidewalls 16 of the corrugation 12. While the device 20 has been shown mounted to the roof (top wall) o the container 10, it will be recognized by those skilled in the art that the device 10 may be mounted to any surface, exterior or interior, of the container 10, such as a side wall or rear door panel where projection above the corrugations is less of a concern. For example, with reference to FIG. 11, the device 20 is shown attached to a vertically aligned door panel.

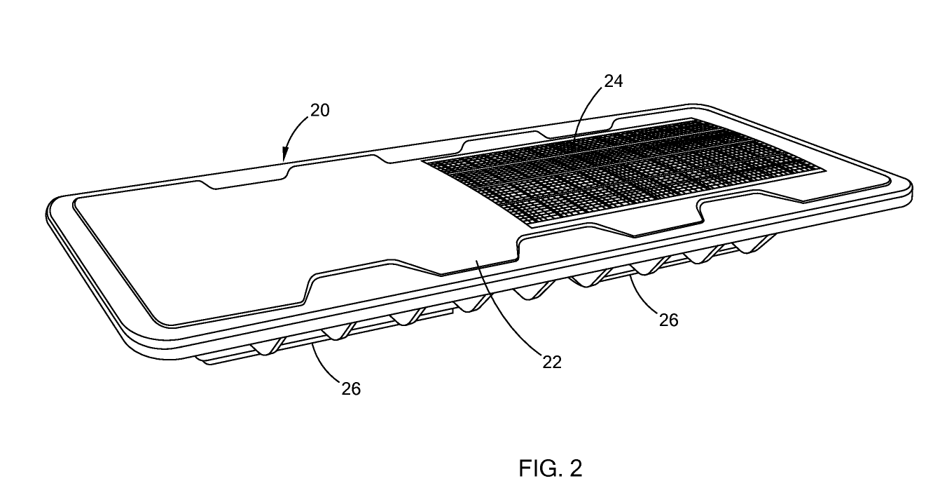

As best seen in FIG. 2, the tracking device 20 generally includes a housing 22 for encasing and protecting the electrical components of the device. The housing 22 incorporates a photovoltaic solar panel 24 into the exterior surface thereof. The solar panel 24 is preferably formed by a flexible sheet containing amorphous silicon (a-Si) technology that is light-weight, robust, and works in low light conditions. The solar panel 24 preferably has an output voltage of 3.6 V to 4.8 V, an output current of approximately 100 mA, and a power output of approximately 0.36 W to 0.48 W. The output voltage of the solar panel 24 is preferably equal to or higher than a maximum voltage of the supercapacitor 142, discuss further hereinbelow. A preferred size of the solar panel 24 is approximately 90 mm by 145 mm. The PV cells are embedded between layers of encapsulation materials such as ETFE (Ethylene Tetrafluoroethylene), which is highly light transmissive, has very high scratch resistance and is self-cleaning due to low frictional resistance. The lower (non-exposed) protective layer may be formed from thermoplastic polyurethane (TPU).

The housing 22 is preferably injection molded of a plastic that exhibits the durability, flexibility, and strength to last the life of the device 20. The solar panel 24 may be insert molded into the housing 22. Plastics such as polycarbonate (PC), acrylonitrile styrene acrylate (ASA), acrylonitrile butadiene styrene (ABS), filled polypropylene (PP), polyvinylchloride (PVC), and Nylon, or blends thereof, may be used to form the housing 22.

The tracking device 20, and in particular a bottom surface of its housing 22, is preferably attached to the container 10 using one or more adhesive tapes 26. A preferred adhesive tape is a dual sided tape for automotive applications. Other adhesives, tapes, magnets, mechanical fasteners and the like may be employed as is known in the field. Use of the adhesive tapes 26 or other fastening devices allows for a robust connection to the container 10, and allows for the device 20 to be mounted at various orientations, such as on a vertical panel or below a horizontal panel.

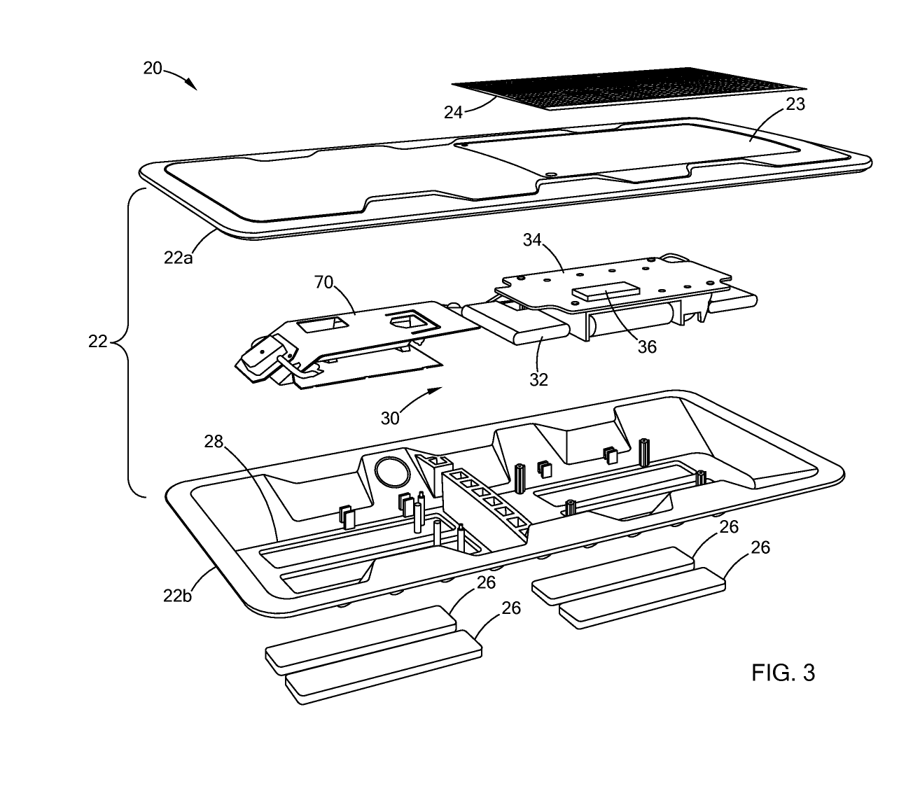

Turning now to FIG. 3, an exploded view of the tracking device 20 is shown. The housing 22 generally includes a lid 22a having a thin recessed area 23 for receiving the solar panel 24 and a through-hole for wiring. The housing body 22b generally defines an interior space 28 for receiving various components of the device 20, such as an antenna 70 forming part of the communication system 30, a power system 32, and a printed circuit board (PCB) 34 for related electrical components including a microcontroler 36.

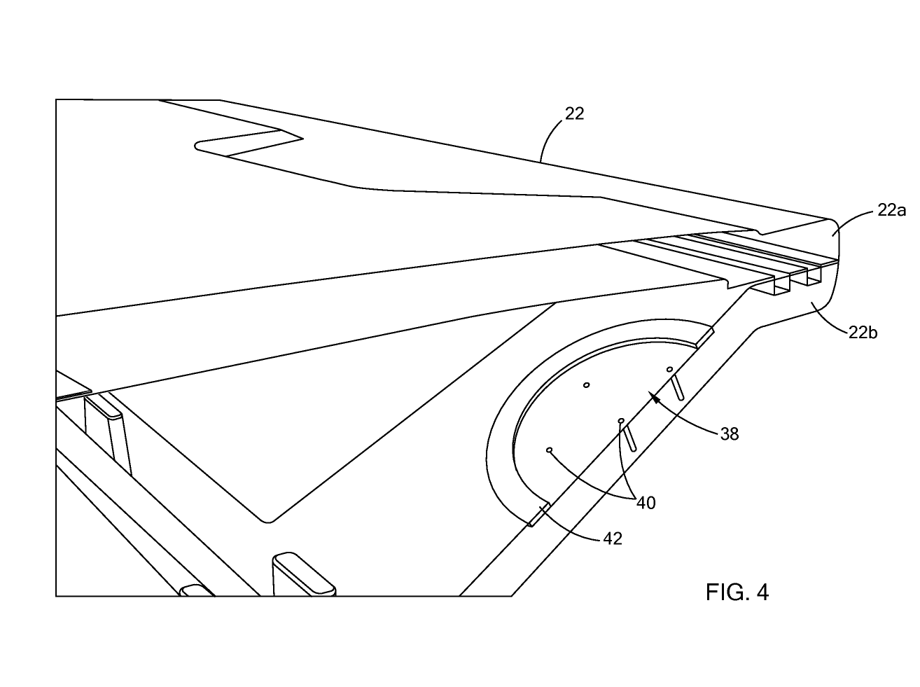

As seen in FIG. 3 and the cut-away of FIG. 4, the lid 22a of the housing is preferably hermetically sealed to the body 22b through plastic welding techniques, such as vibration welding or hot plate welding, preferably utilizing two parallel ribbed/channel structures, each of which extends circumferentially around the outer edge of the lid 22a and body 22b. Many techniques may employed for sealing the two components together including latches, tongue and groove, mechanical fasteners with gaskets, and adhesives. Since the housing 22 is hermetically sealed, it preferably includes a vent 38 formed by a plurality of small passageways 40 formed through the wall of the body 22b, along with a membrane vent 42.

The membrane vent 42 is preferably made of a gore material, which will preferably equalize the pressure between the interior of the device 20 and the exterior of the device 20. The vent 38 and membrane 42 do not provide a pressure tight seal, so pressure can therefore be equalized. The vent 38 and membrane 42 will prevent or limit penetration of rainwater, wash water, particles, and dirt from entering the interior of the device 20. Additional vents 38 and membranes 42 can be added to other locations of the device 20, if desired, or the position of the vent 38 and membrane 42 could be altered, if desired.

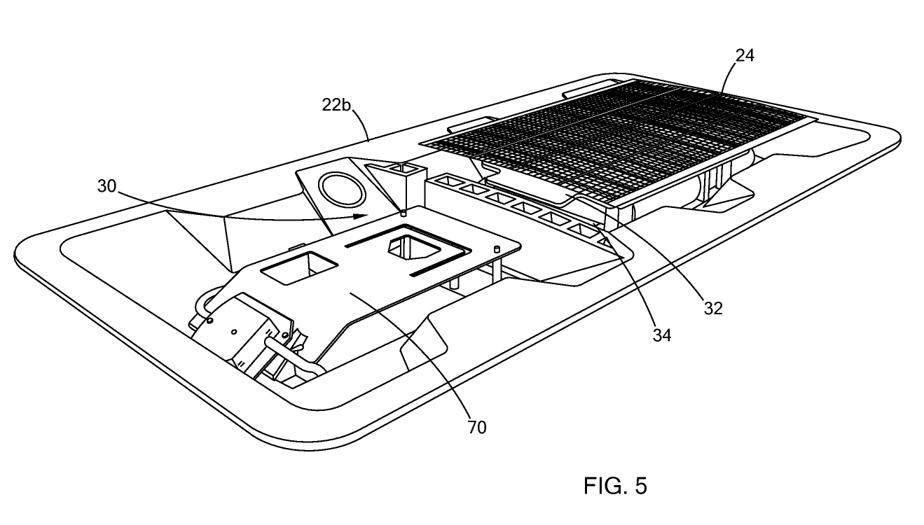

Turning now to FIG. 5 the housing body 22b is shown with the communication system 30, antenna 70, power system 32, and PCB 34 with related electronics as described further hereinbelow. The solar panel 24 has also been shown superimposed above the PCB 34. Various structures are molded in the body 22b for mechanical attachment of these systems and components.

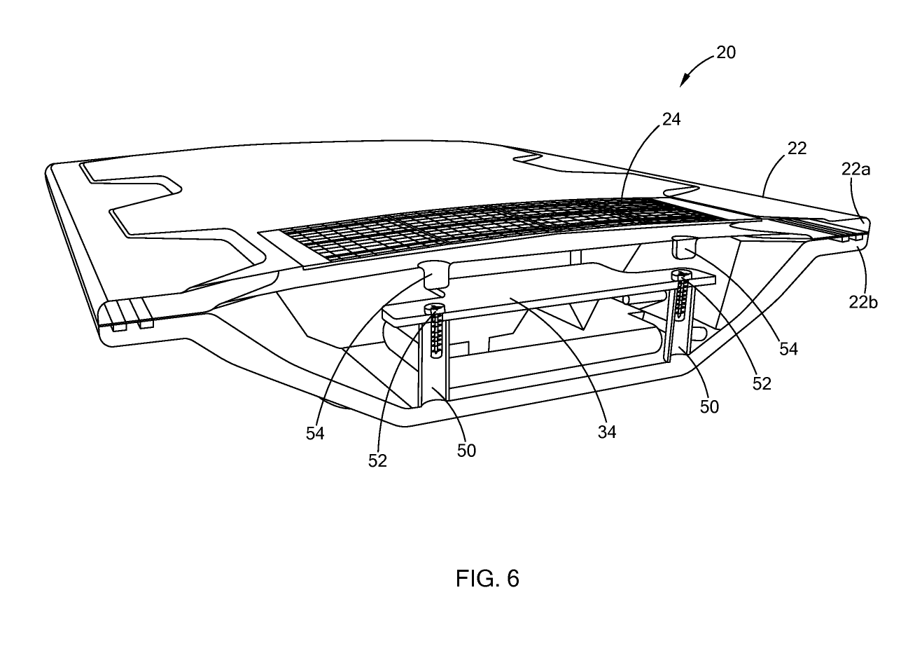

As best seen in FIG. 6, the housing 22 provides a unique support structure for the solar cell 24. In particular, the housing body 22b includes a plurality of posts 50 which can be used to mount the PCB 34 using a mechanical fastener 52, such as a screw or bolt driven into the post 50. A lower surface of the lid 22a is also molded to define corresponding knobs 54 which are vertically aligned with the post 50 and fasteners 52. Further, the lid 22a has a bowed curvature, namely a concave curvature facing the body 22b, which essentially provides an arch structure providing resistance against external forces on the lid 22a. The material of the lid 22 will allow for bending under a sufficient force. However, due to the size, shape and alignment of the knobs 54 with the posts 50 and fasteners 52, the amount of flexure of the lid 22a is limited to prevent the housing 22, the solar cell 24, or the electrical components such as the PCB 34, from being damaged. Any number of corresponding knobs 54 and post 50 may be located throughout the housing 22 to provide adequate support across the upper surface area of the tracking device 20.

Of course, it will be appreciated that the lid 22a can also be made to be generally flat. For example, in instances where the device 20 will be mounted to a vertical surface, the likelihood of external forces on the lid 22a, such as being stepped on or items being stacked on the device 20, is decreased. Of course, either a bowed shape or flat shaped lid 22a could be used in either case.

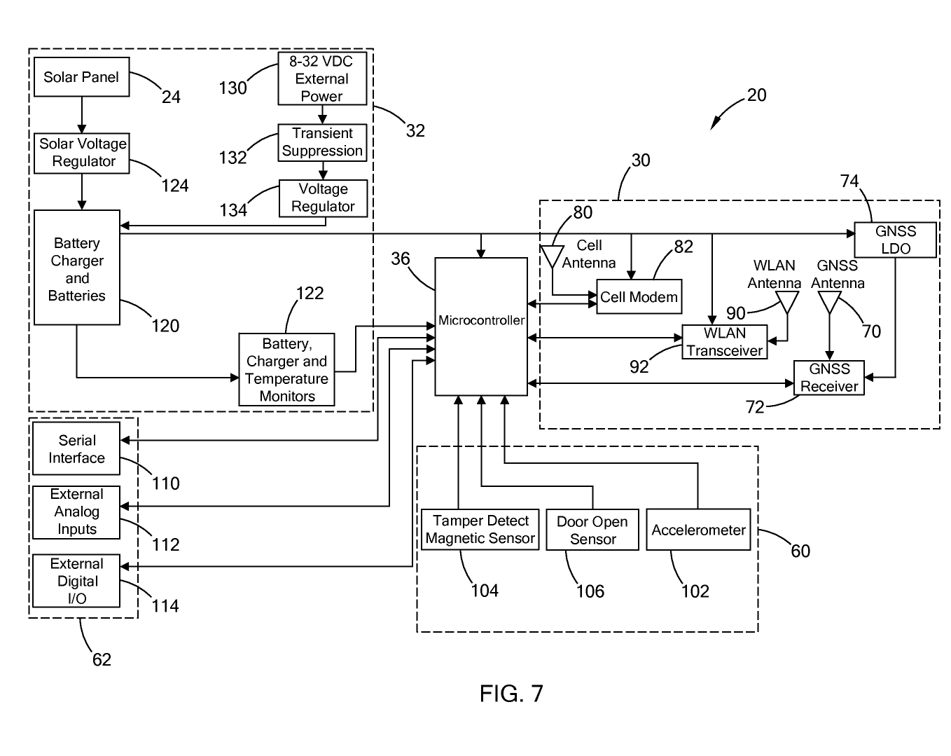

Turning now to FIG. 7, a schematic of the tracking device 20 has been depicted. The microcontroller 36 is a microprocessor programed for executing the functions described hereinbelow, and includes interfaces for controlling the GPS receiver, cell modem, WLAN transceiver, analog inputs for monitoring voltages, and digital input/outputs for turning devices on and off and monitoring the state of switches and devices. The microcontroller 36 generally interconnects the communication system 30, the power system 32, and optionally a sensor system 60 and an interface system 62. The communication system 30 includes a satellite antenna 70, which preferably is a Global Navigation Satellite System (GNSS), coupled to a GNSS receiver 72. Such satellite systems are well known and may include the global positioning system (GPS; United states), (Glonass; Russia), (Galileo; Europe), (Compass; China) and others, either individually or in combination. The GNSS receiver 72 is provided with power through a low-dropout regulator (LDO) 74 that receives electricity from the power system 32. The GNSS receiver 72 communicates with the microcontroller 36 to provide information regarding the location of the tracking device 20.

The tracking device 20 communicates its location and status to a back office application (not shown) via a cellular antenna 80 and transceiver 82. The cellular transceiver 82 can be implemented as a Global System for Mobile Communications (GSM)/General Packet Radio Service (GPRS) (GSM/GPRS), or Code Division Multiple Access (CDMA) depending on the cellular carrier that is used. One preferred cellular transceiver 82 or modem is the Lisa U200 provided by U-Blox which a world wide WCDMA (UMTS) and GPRS/Edge unit having a wide temperature range and low idle mode current. Additionally, the cellular transceiver 82 may also be used to provide location information to the microcontroller 36 such as is currently done with other cellular mobile devices and well known in the art.

Optionally, a Wireless Local Area Network (WLAN) antenna 90 and transceiver 92 may be provided to offer local communication with adjacent tracking devices 20 or other devices on a local area network. Similarly, the WLAN antenna 90 and transceiver 92, when connected in a network, can be used to provide location information to the microcontroller 36 as is well known in the art. Other local area communication protocols may also be used in conjunction with or in place WLAN, such as Bluetooth or ZigBee communication protocols. The cellular transceiver 82 and/or network transceiver 92 communicate with a master server, such as a computer, which receives the data from the tracking device 20 utilizing a predefined internet address or other identifiable address or number, and can employ security techniques such as firewalls and encryption.

A variety of sensors may be utilized to provide additional information to the microcontroller 36, such as a 3-axis accelerometer 102 which senses whether the tracking device 20 is stationary or in motion. A tamper detect magnetic sensor 104 may be utilized to detect when the tracking device 20 is installed on or removed from a ferrous surface. The sensor 104 is passive and thus requires no power to operate, saving battery power. The sensor 104 may be completely integrated into the housing 22 and so as not to be visible from the exterior. A door open sensor 106 may also be used to detect when a door to the container 10 is opened, or there has been an attempt to open the door.

The tamper detect sensor 104 and door open sensor 106 will be described in further detail herein below.

The interface system 62 may include various interfaces such as a serial interface 110 which can be implemented as RS-232, RS-422, RS-485, Firewire, Ethernet, USB, UART and other serial communication architectures as is known in the art. Various external analog inputs 112 or external digital inputs/outputs 114 may be provided to interface with external sensors, switch closures and the like, such as sensors to detect the presence of cargo, temperature and humidity.

The power system 32 includes a battery system 120 to provide power to the communication system 30 and to the microcontroller 36. Various sensors 122 may be provided between the battery system 120 and the microcontroller 36 to monitor the battery, charger and temperature. The battery system 120 is rechargeable, and thus the power system 32 includes the solar panel 24 which outputs electricity to a solar voltage regulator 124 for provision to the battery system 120. It will be recognized that the solar panel 24 and regulator 124 are one renewable energy system that may be used to charge the battery 120 and/or power the communication system 30. For example, a wind energy system may also be employed in place of the solar system. Further, if the tracking device 20 is located near another source of external power 130 (such as a connection to the grid (traditional power outlet) or the electrical system of a truck, other vehicle or remote generator), the device 20 is provided with a transient suppressor 132 and voltage regulator 134 for providing appropriate power to the battery system 120. The external power system may also include a receiver and regulator for wireless charging. Appropriate ports and connectors are optionally provided in the housing 22 for such electrical connections, as needed for each particular application.

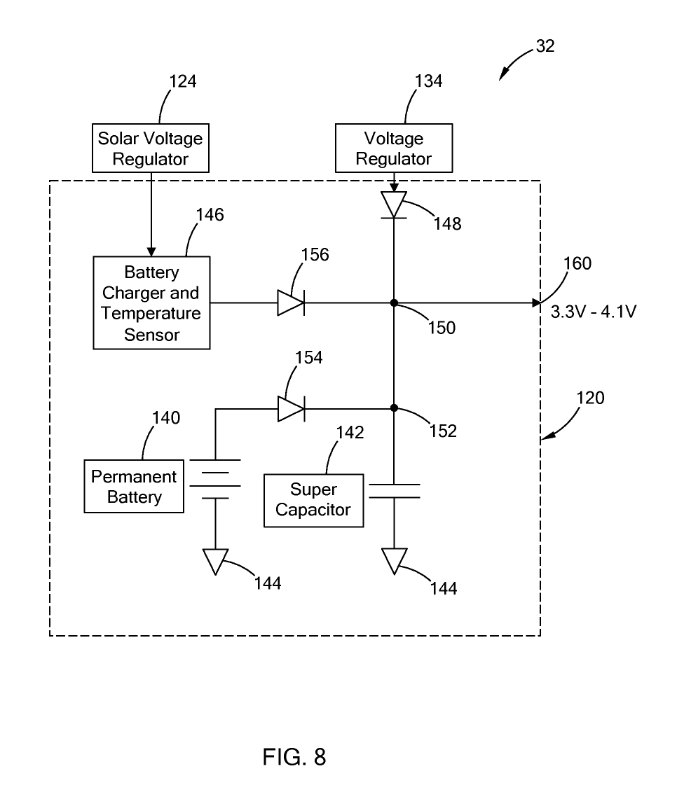

Turning now to FIG. 8, the power system 32, and in particular the battery system 120, is described in greater detail. In order to provide the tracking device 20 with greatly increased lifespan, currently tested to be ten to twenty (or greater) years, a permanent battery 140 is placed in parallel with a rechargeable power source 142. The rechargeable power source can be one of various rechargeable power sources. In one preferred approach, the rechargeable power source 142 is in the form of a Hybrid Layer Capacitor (“HLC”). In another approach, the rechargeable power source 142 can be in the form of a supercapacitor or a re-chargeable battery. The permanent battery 140 is a class of permanent batteries that has a large temperature range, a low self-discharge rate and high energy densities that give them a long life in excess of ten years. The rated temperature range preferably meets or exceeds −40° C. to 85° C. These permanent batteries 140 are preferably from the family of lithium/oxyhalide electrochemical cells, and include the chemistries of lithium thionyl chloride, lithium sulfuryl chloride or lithium bromine chloride. Preferably the permanent battery 140 has a nominal capacity of 8.5Ah at 3 mA, to 2V, a rated voltage of 3.6 V, and an operating temperature range of −55° C. to 85° C. The permanent battery 140 has a maximum pulse current that is insufficient for powering the communication system and microcontroller 36, and may include a continuous current of 100 mA or less, preferably 75 mA, and a maximum pulse current of 300 mA or less, preferably 200 mA.

While various rechargeable power sources 142 may be used, such as those of lithium-ion technology, a hybrid layer capacitor (HLC) is preferably used. Of course, another supercapacitor could also be used. Supercapacitors are generally divided into three families, which include double-layer capacitors with carbon electrodes, pseudocapacitors with the electrodes made of metal oxides or conducting polymers, and hybrid capacitors with special electrodes that exhibit both significant double-layer capacitance and pseudocapacitance, such as lithium-ion capacitors. Most preferably, the rechargeable power source 142 is a hybrid layer capacitor, or HLC, that has a rated temperature range that meets or exceeds −40° C. to 85° C. One preferred HLC has a maximum charge voltage of 3.95 V to 4.1 V, a charge current of 100 mA Max, a charge temperature range of −40° C. to 85° C. (when the charge current is limited to 20 mA), and supports a maximum discharge current of 3.0 A with a 1 second burst (pulse) capacity of 5.0 A. The electrical discharge has a nominal current of 250 mA, end of discharge of 2.5V at room temperature, and a discharge temperature range of −40° C. to 85° C., and has an expected lifetime that exceeds 10 years.

The permanent battery 140 has an output current that is limited to slowly charge the rechargeable power source 142. In particular, it is limited to the extent that the permanent battery 140 itself is not suitable for the pulsed loads required by the communication system 30, namely satellite system regulator 74, the WLAN transceiver 92 or the cellular transceiver 82. However, the rechargeable battery source 142 provides high current bursts of over 3.0 A to meet the demands of the communication system 30. The maximum charge voltage of the permanent battery 140 is preferably less than the maximum charge voltage of the rechargeable power source 142, whereby charging of the rechargeable power source 142 beyond the voltage of the permanent battery 140 primarily occurs through the solar system 24 or the external power 130.

As seen in FIG. 8, the permanent battery 140 and rechargeable power source 142 are connected to a common ground 144 which could also be depicted as a negative lead from the battery system 120, opposite the positive lead 160. When external power is available, the voltage regulator 134 feeds the microcontroller 36, the communication system 30, and/or the battery system 120. Current from the voltage regulator 134 is provided through a first node 150 to the communication system 30 via the positive lead 160, and/or to the rechargeable power source 142 through a second node 152. A first diode 148 (an external power diode) is utilized to separate the voltage regulator 134 (and the components behind it) from drawing power from the battery system 120, and is positioned between the first node 150 and the voltage regulator 134. In this way, leakage current in the voltage regulator 134 does not drain the battery system 120. A second diode 154 (a battery diode) is positioned between the second node 152 and the permanent battery 140 to prevent current flowing from the voltage regulator 134 to the permanent battery 140 and thereby damaging it.

The solar system (or other renewable energy system) is connected in parallel to the external power source and its voltage regulator 134 across node 150. Power from the solar panel 24 is provided through the solar voltage regulator 124 to the battery system 120. A battery charger and temperature sensor 146 controls the charging of the rechargeable power source 142 from the solar panel. The temperature sensor reduces the charge current or turns the charger off entirely when the temperature of the module falls below or goes above the prescribed temperature range, thus protecting it from damage. For example, the charge current would be reduced or turned off when the temperature falls below −20° C. or is above 50° C. Likewise, the device 20 can be programmed to function at the extreme temperature ranges with a reduced number of messages the device has the capacity to send.

The charge current from the solar system is passed through a third diode 156 (a solar diode) positioned between the solar voltage regulator 124 and the first node 150. This prevents the battery charger and temperature sensor 146, or the solar voltage regulator 124, from drawing any power from the permanent battery 140 or the rechargeable power source 142. As with the external power system, leakage currents in the solar system are prevented from draining the rechargeable power source 142. Likewise, the diode 156 prevents any current from the external power 130 from damaging the battery charger and temperature sensor 146 or the solar voltage regulator 124. The second diode 154, by virtue of its position between the second node 152 and the permanent battery 140, prevents current flowing from the solar voltage regulator 124 to the permanent battery 140 and thereby damaging it.

In operation, the permanent battery 140 charges the rechargeable power source 142 up to approximately 3.3 V to 3.6 V. The solar panel 24 and/or the external power 130 then charges the rechargeable power source 142 up to approximately 4.1 V. When solar power or external power is available, the microcontroller 36 and communication system 30 may operate directly therefrom. When there is no or insufficient light available, or when there is no external power, the microcontroller 36 and communication system 30 can draw current from the rechargeable power source 142, which is charged by the permanent battery 140. As noted above, the rechargeable power source 142 is well suited for the high bursts of current, such as two amps or greater required by the communication system 30. As power is depleted from the rechargeable power source 142, it can be charged by the permanent battery 140. The battery system 120 thus outputs power at 3.3 V to 4.1 V depending on its level of charge and conditions.

Through this unique arrangement, the rechargeable power source 142 can be charged by the solar panel 124 or the external power source 130 without damaging the permanent battery 140 due to the diode 154. Likewise, the diodes 148 and 156 prevent the rechargeable power source 142 and permanent battery 140 from being drained by the voltage regulator 134, battery charger and temperature sensor 146, or the solar voltage regulator 124.

The diodes 148, 154, and 156 are preferably passive diodes such as Schottky diodes. Alternatively, the diodes 148, 154, 156 may be ideal diodes. As is known in the art, an ideal diode is a semiconductor device which has an extremely large breakdown voltage such that the diode provides a nearly ideal and complete block against the flow of current in one direction. A typical passive diode such as a Shottky diode has a voltage drop of about 0.3 V, whereas an ideal diode has a very low voltage drop of less than 0.1 V. Accordingly, the at least the second diode 152, and optionally the first and third diodes 148 and 156 are ideal diodes. In one preferred embodiment, the first diode 148 is a passive diode while the second diode 154 and third diode 156 are ideal diodes. A precision rectifier (super diode) could also be used for any one or combination of the diodes 148, 154, 156.

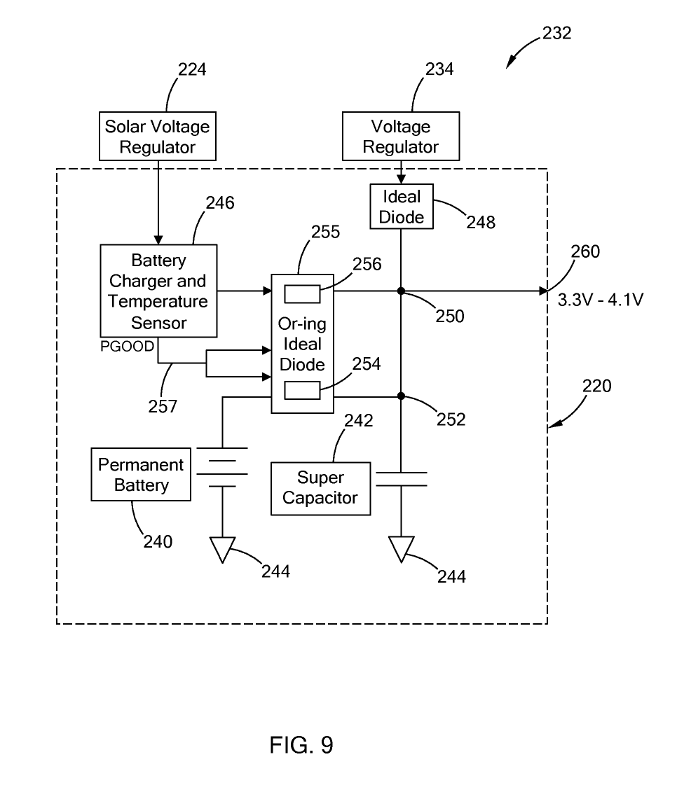

Another embodiment of a power system 232 and battery system 220 are shown in FIG. 9. In this embodiment the external battery diode 248 is an ideal diode, while an OR-ing ideal diode 255 operates as the battery diode 254 and solar diode 256. As with the prior embodiment, the battery system 220 includes a permanent battery 240 in parallel with a rechargeable power source 242, and solar battery charger 246, to provide power through positive terminal 260. The battery charger 246 receives power from the solar voltage regulator 224, while the external power voltage regulator 234 provides power through diode 248 and node 250.

The OR-ing ideal diode 255 is an integrated circuit that functionally contains two ideal diodes, namely solar ideal diode 254 and battery diode 256 on the same chip. The OR-ing ideal diode 255 also contains enable line circuitry receiving an output signal 257 from the solar battery charger 146. The output signal 257 may be a PGOOD signal or the battery voltage itself, and may also be split (as shown) to provide an input for each diode 254, 256. When the output signal 257 goes higher, e.g. above a threshold, the OR-ing ideal diode 255 turns on the solar diode 254 to allow current to flow from the solar panel 24 and its charger 246 to node 250, node 252, and the rechargeable power source 242. The same signal 257, when high, also is used to turn off the ideal diode 256 such that the permanent battery 240 is essentially switched off behind node 252. When the output signal 257 is below a threshold, the solar diode 256 is turned off to disconnect the solar system, and battery diode 254 is turned on to permit charging of the rechargeable power source 242 from the permanent battery 240 through node 252 and their parallel connection.

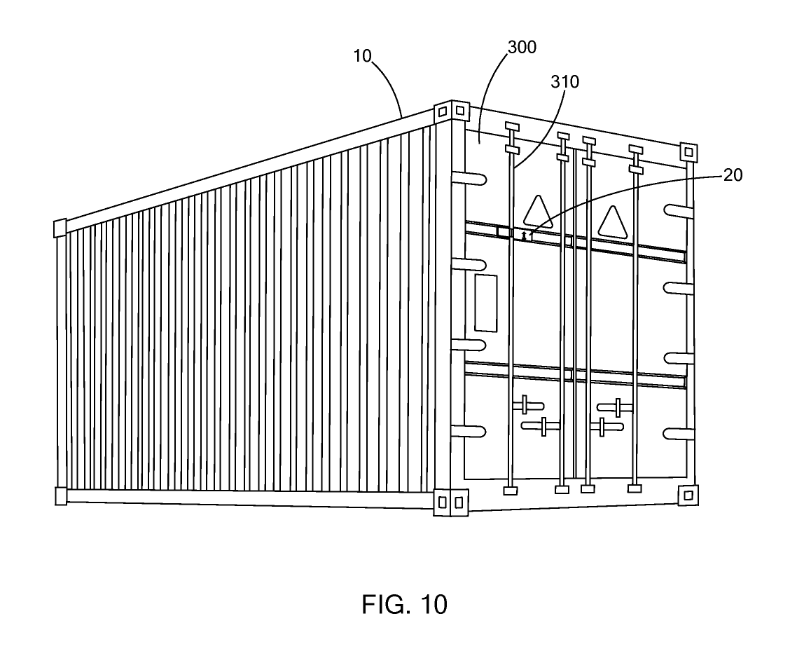

Turning now to FIGS. 10 and 11, the device 20 is mounted to a door 300 of the container 10. As stated above, the device 20 can include the door open sensor 106 (FIG. 7) for determining whether the door 300 of the container 20 has been opened or whether there has been an attempt to open the door 300. More particularly, the door open sensor 106 will communicate with the microcontroller 36 and the device 20 will send a message indicating that the door 300 has been opened or, in some cases, that there has been an attempt to open the door 300.

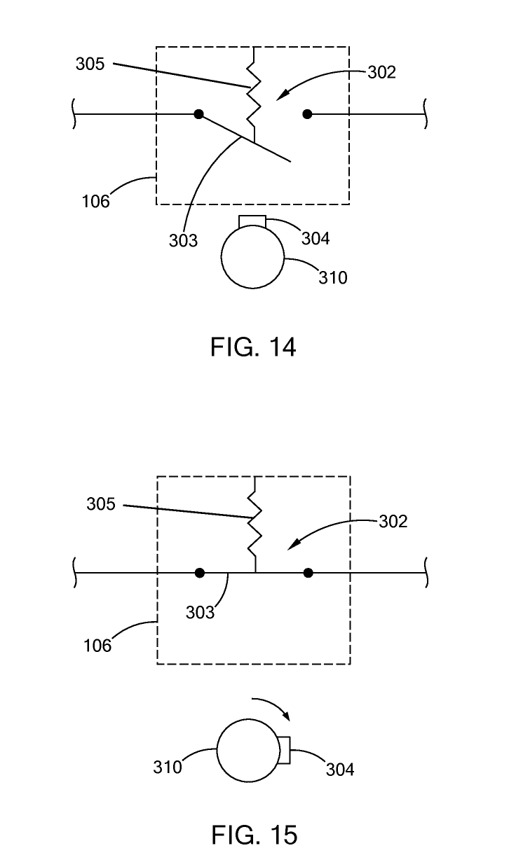

As shown in FIG. 14, the door open sensor 106 includes a normally open switching device 302 that is biased to the closed position. The switching device 302 is a passive device, and being normally open results in the door open sensor 106 not drawing any power while the switching device 302 remains open. The switching device 302 has a moveable element 303 that is biased toward the closed position, such as by a spring 305. The switching device 302 is maintained in the normally open state due to magnetic forces acting on the switching device 302, which counteracts the spring's bias in the switching device 302. Namely, the magnet 304 acts on the moveable element 303 which is formed of a metal or other material attracted to the magnetic field. When the magnetic forces are reduced to a level where the spring 305 can overcome the magnetic forces, the moveable element 303 will move to complete the circuit and thus the switching device 302 will transition into a closed state, which in turn creates a signal that the door 300 has been opened. The biasing of the switching device 302 is preferably provided by a spring, however, other biasing mechanisms such as elastic bands, gravity or the like could also be used.

With reference to FIGS. 12-14, the magnetic forces are provided by an exterior magnet 304 mounted on the door's latching bar 310. The exterior magnet 304 can be any type of magnet that produces a magnetic field strong enough to counteract the bias in the switching device 302. For example, the magnet 304 can be a permanent bar or circular magnet, electromagnet, or the like. The exterior magnet 304 can be positioned at various distances from the switching device 302 depending on the strength of the magnet 304. In one approach, the magnet 304 is positioned about 1-2 inches from the switching device 302.

The placement of the magnet 304 or distance from the sensor 106 will generally depend on the container 10 on which the device 20 is being installed. As shown in FIGS. 10 and 11, the container 20 includes one or more doors 300, which is where the device 20 is preferably installed in order to operate with door open detection functionality.

The doors 300 of a typical shipping container 10 include one or more vertically aligned and rotatable door latching bars 310. The bars 310 are held in place via a latching mechanism (not shown), and with the bars 310 held in place, the doors 300 are prevented from being opened. To unlatch the bars 310, the bars 310 are rotated, and sometimes lifted, thereby allowing the doors 300 to be opened.

Accordingly, as shown in FIGS. 12 and 13, the exterior magnet 304 is attached one of the bars 310 that is rotatable to unlock the door 300. The exterior magnet 304 is attached to the bar 310 when the bar 310 and door 300 are in the latched and closed position.

In one embodiment, the magnet 304 is attached to the bar 310 via an adhesive tape 312, such as VHB tape manufactured by 3M Corporation. The tape 312 is preferably wrapped around the bar 310, with the magnet 304 placed on the tape 312 and the tape 312 continued to be wrapped around the magnet 304 and bar 310, whereby the magnet 304 is encased within the tape 312. In other embodiments, the magnet 304 can be attached to the bar 310 in other ways, such as via an applied adhesive between the bar 310 and magnet 304, mechanical fasteners, clamping, welding, or the like. In another approach, the magnet 304 could be embedded in the bar 310.

With the magnet 304 attached to the bar 310 for movement therewith, when the bar 310 is rotated the magnet 304 will likewise be rotated, as shown by the arrow in FIG. 13. Rotation of the magnet 304 will cause the magnet 304 to move away from the sensor 106 that is inside the device 20. With the magnet 304 moved away from the sensor 106, the bias in the switching device 302 will cause the moveable element 303 to move into the closed position, completing the circuit and signaling that the door 300 has been opened or attempted to have been opened. In addition to, or rather than, relying on rotational movement of the bar 310, the sensor 106 and magnet 304 can be arranged to operate based on the axial movement of the bar 310, such as when the bar 310 is lifted upwards to unlatch the doors 300, or if the bar 310 is pulled away or removed.

FIGS. 14 and 15 illustrate the switching device 302 in the normally open state and the closed state, respectively. FIG. 14 illustrates the magnet 304 positioned near the switching device 302 to overcome the bias in the switching device 302. FIG. 15 illustrates the magnet 304 positioned away from the switching device 302, with the bias of the switching device 302 moving the switching device 302 to the closed position.

It will be appreciated that the above described operation of the switching device 302 being biased toward the closed position where the magnet 304 acts to overcome the bias keep the switch open could also be reversed. For example, the bias in the switching device 302 could be to bias it open, and rotation of the bar 310 to a position that allows for the door 300 to be opened could move the magnet 304 closer to the switching device 302, thereby causing the switching device 302 to close and complete the circuit, indicating that the door 300 could be opened. In this case, the spring 305, rather than being a tension spring, would be formed as a compression spring. The magnet 304 could also be mounted to the moveable element 303, and a magnetically reactive protrusion on the rod extending towards the switching device 302 (the protrusion existing or formed/attached to the rod) can be used to vary the magnetic force on the moveable element 303.

Operation of the door open sensor 106 operates in addition to the power management operation described previously. Accordingly, the operation of the door open sensor 106 is as follows.

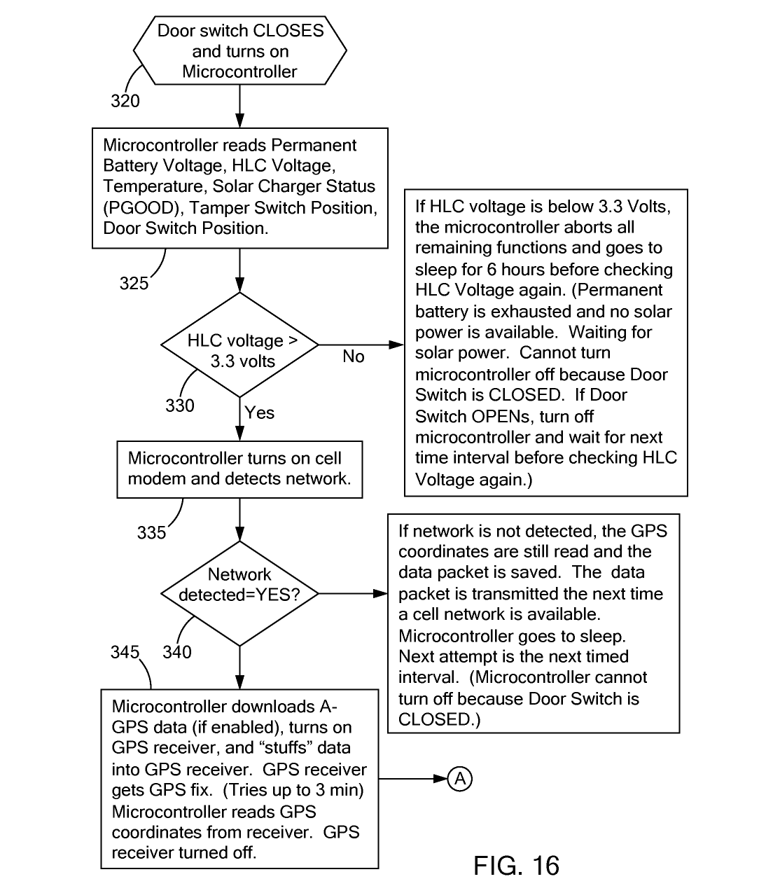

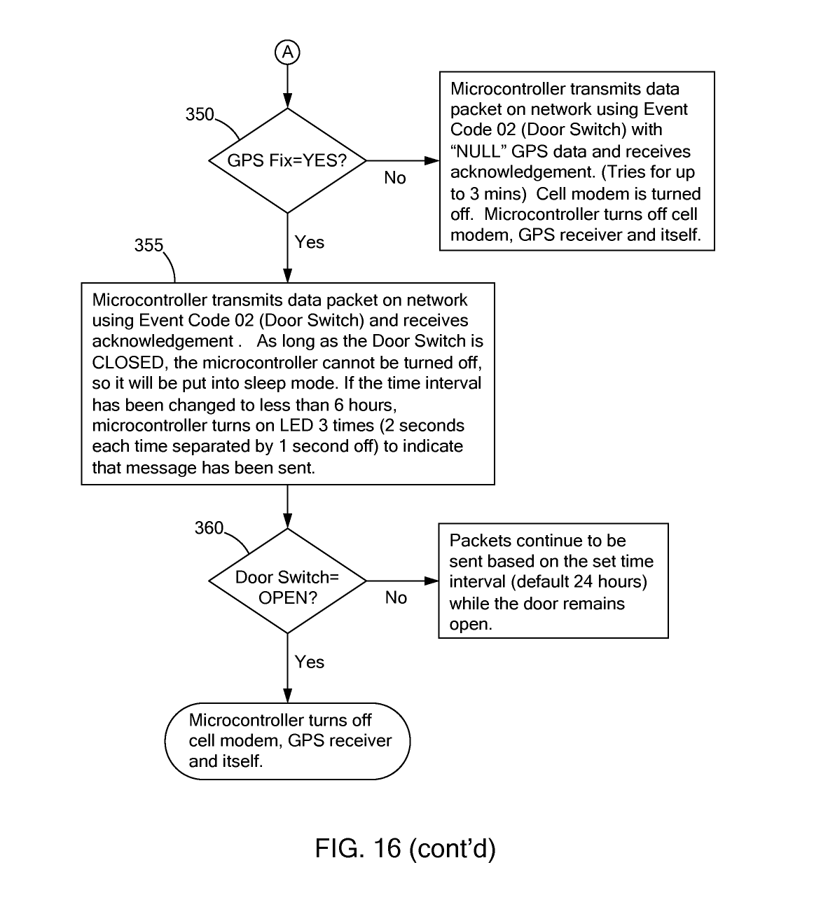

With reference to the method shown in FIG. 16, upon detection at step 320 that the switching device 302 has closed, meaning that the rod 310 has been rotated and the door 300 has been opened or could be opened, the microcontroller 36 is turned on if it was not already turned on.

At step 325, the microcontroller 36 reads the permanent battery voltage, the HLC voltage, the temperature, the solar charger status (PGOOD), and the door switching device position (in this case the door switching device 302 is closed). The microcontroller 36 will also read the status of other sensors or switches that may be installed, such as the tamper detect sensor 104.

At step 330, the voltage level of the HLC 142 will be evaluated. If the voltage is equal to or lower than 3.3 volts, the microcontroller 36 will abort all remaining functions and sleep for predetermined period of time, preferably about 6 hours, before checking the HLC voltage again. The HLC voltage may be low for various reasons. In most cases, the HLC voltage would be below 3.3 volts because the permanent battery has been drained below a charging level and no solar power or external power source is available to charge the HLC. Thus, the microcontroller 36 will wait for about 6 hours in the event that solar charging (or other external charging) has occurred. The time delay may be varied based on the application, or an indication that charging of the HLC or battery is ongoing. The microcontroller 36 will sleep instead of turning off because the door switching device 302 is in the closed position. If the door switching device 302 opens, the microcontroller 36 will turn off, and will wait until the next predetermined time interval to turn back on and check HLC voltage. However, this setting is configurable, and the microcontroller 36 can remain in a sleep mode even after the switching device 302 opens.

If the voltage level of the HLC determined at step 330 is greater than 3.3 volts, the microcontroller 36 will turn on the cell modem and detect a cellular network at step 335. At step 340, the microcontroller 36 will determine if a network (such as cellular) is detected. If not, the GPS coordinates are still read and the data packet is saved. The data packet will be sent the next time a cell network is available. Alternatively or additively, the microcontroller 36 may also check if other communications networks, such as LAN, are available to send the indication. The microcontroller 36 will sleep, and the next attempt will occur at the next predetermined time interval. The microcontroller 36 will not turn off because the door switching device 302 is closed, so the microcontroller 36 will sleep.

If a network is detected at step 340, at step 345, the microcontroller 36 downloads A-GPS data (if enabled), turns on the GPS receiver, and stuffs data into the GPS receiver. The GPS receiver attempts to get a GPS fix, and will try for up to 3 minutes to do so. The microcontroller 36 will read the GPS coordinates from the receiver, and the GPS receiver will then turn off.

At step 350, the microcontroller 36 will determine whether it has a GPS fix. If not, the microcontroller 36 will transmit the data packet on the network with an event code corresponding to the door switching device 302 being closed (the rod 310 has been rotated) along with NULL GPS data and will attempt to receive acknowledgment for up to 3 minutes. That is, the door open signal will be transmitted without location data. The microcontroller 36 will then turn off the cell modem, the GPS receiver, and itself.

If the microcontroller 36 does has a GPS fix as determined at step 350, then at step 355 the microcontroller 36 will transmit the data packet having location information, including the event code for the door switching device 302 being closed (rode 310 has been rotated) and will receive acknowledgement. Because the door switching device 302 is closed, the microcontroller 36 will sleep.

At step 360, the microcontroller 36 will determine if the door switching device 302 is open. If not, data packets will continue to be sent based on a predetermined time interval, such as every 24 hours, while the door switching device 302 remains closed (the rod 310 in the unlocked position). If, at step 360, it is determined that the door switching device 302 is open, meaning that the rod 310 has been rotated back into the locked position causing the magnet 304 to counteract the bias in the switching device 302 to move it back to the open position, then the microcontroller 36 will turn off the cell modem, the GPS receiver, and itself.

The above described process for communicating the detection of the door switching device 302 being closed is one example. It will be appreciated that variations can be made to the above device to log instances of the switching device 302 being closed and communicating them at various intervals depending on other detected conditions, such as by varying the predetermined time periods, using other means for identifying location such as LAN identity or cell tower identity, or the like.

The above described device 20 having the door sensor 106 is particularly beneficial as it does not draw power while the magnet 304 and rod 310 are rotated to the latched position, which preserves power, and will not check for door open states until such time as the rod 310 and magnet 304 are rotated, which also preserves power.

The device 20 is also particularly suited to easy installation on existing containers 10, allowing for containers 10 that are already in service to be retrofitted with the device 20 to realize the advantages of the device 20 and door open sensor 106 without substantial modifications.

For example, the magnet 304 and device 20 can be installed to the container without requiring electrical wiring or modification (though the device 20 may be attached to an external power source if desired). The magnet 304 is mechanically attached without electrical attachments, although if the magnet 304 is an electromagnet it could be provided with its own battery or power source.

The magnet 304 is, in a preferred form, in an elongate bar shape that is longer than the size of the sensor 106, which allows for the magnet 304 to be installed without requiring an exact or precise location. The midpoint of the magnet 304 could, for example, be installed above or below the midpoint of the sensor 106, namely moveable element 303, and still provide the requisite magnetic force to keep the switching device 302 in the open position when the rod 310 is rotated to the closed door position.

The above description refers to detection of the door 300 being opened based on rotation of the rods 310. However, it will be appreciated that other door closing mechanisms could be used on various containers 10. For example, a door 300 could be opened by lifting the rod 310 instead of rotating it, and/or the rod 310 may be allowed to rotate without it unlocking the door 300. The rod 310 may be pulled away from the door 300, in another example, to open the door 300. In such containers 10, it may be desirable to maintain the door switching device 302 in the open position when the rod 310 is rotated. In this case, an annular magnet (not shown) could be placed entirely around the rod 310. The annular magnet could thereby move away from the sensor 106 by being lifted up or pulled away. Of course, other variations of moving the magnet 304 away from the door switching device 302 to allow the door switching device 302 to move to the closed position could also be used.

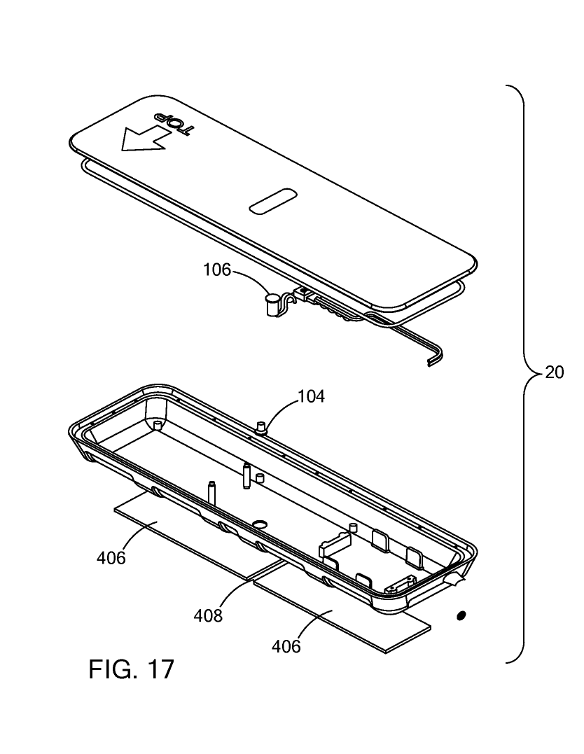

With reference now to FIG. 17, additionally or alternatively to the door sensor 106, the device 20 includes the tamper detect sensor 104, as mentioned above (FIG. 7). The tamper detect sensor 104 is arranged to detect when the device 20 has been removed from the container 10, or when an attempt has been made to remove the device 20 from the container 10. More particularly, the tamper detect sensor 104 will communicate with the microcontroller 36 and the device 20 will send a message indicating that the device 20 has been removed from the container 10 or that an attempt has been made to remove the device 20.

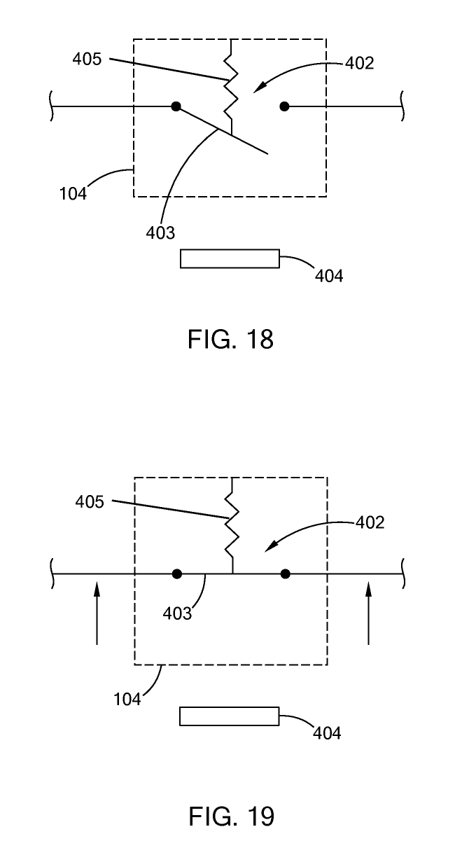

As shown in FIGS. 18-19, the tamper detect sensor 104 includes a normally open switching device 402 that is biased to the closed position. The switching device 402 is a passive device, and being normally open results in the tamper detect sensor 104 not drawing any power while the switching device 402 remains open. The switching device 402 includes a moveable element 403 that is biased towards the closed position, such as by a spring 405. The switching device 402 is maintained in the normally open state due to magnetic forces acting on the switching device 402, which counteracts the bias in the switching device 402. Namely, the magnet 404 acts on the moveable element 403 which is formed of a metal or other material attracted to the magnetic field. When the magnetic forces are reduced to a level where the spring 405 can overcome the magnetic forces, the switching device 402 will transition into a closed state, which will indicate that the device 20 has been removed. The biasing of the switching device 402 is preferably provided by a spring; however other biasing mechanisms could also be used such as elastic bands, gravity or the like can also be used.

With reference to FIGS. 17-19, the magnetic forces are provided by a magnet 404. The magnet 404 can be any type of magnet that produces a magnetic field strong enough to counteract the bias in the switching device 402. For example, the magnet 404 can be a permanent circular or bar magnet, electromagnet or the like. In a preferred approach, the magnet 404 is a circular, disc-shaped, permanent magnet with a diameter of about 9.5 mm and a thickness of about 1.5 mm. Of course, other sizes could also be used. The size and shape of the magnet 404 are selected so that the magnet 404 can rest between the device 20 and the surface of the container 10 on which the device 20 is installed. Accordingly, the magnet 404 preferably has a low profile. Because of the low profile shape of the magnet 404 and its positioning between the container surface and the device 20, the magnet 404 is preferably positioned within 4 mm of switching device 402. When the switching device 402 becomes greater than 4 mm away from the magnet 404, the bias in the switching device 402 will overcome the magnetic force from the magnet 404 and the switching device 402 will transition to a closed state. Of course, other magnet sizes and positions can be selected to control the distance at which the switching device 402 will close.

FIGS. 18 and 19 illustrate the switching device 402 in the normally open state and the closed state, respectively. FIG. 18 illustrates the magnet 404 positioned near the switching device 402 to overcome the spring bias in the switching device 402. FIG. 19 illustrates the magnet 404 positioned away from the switching device 402, with the bias of the switching device 402 moving the switching device 402 to the closed position completing an electrical circuit.

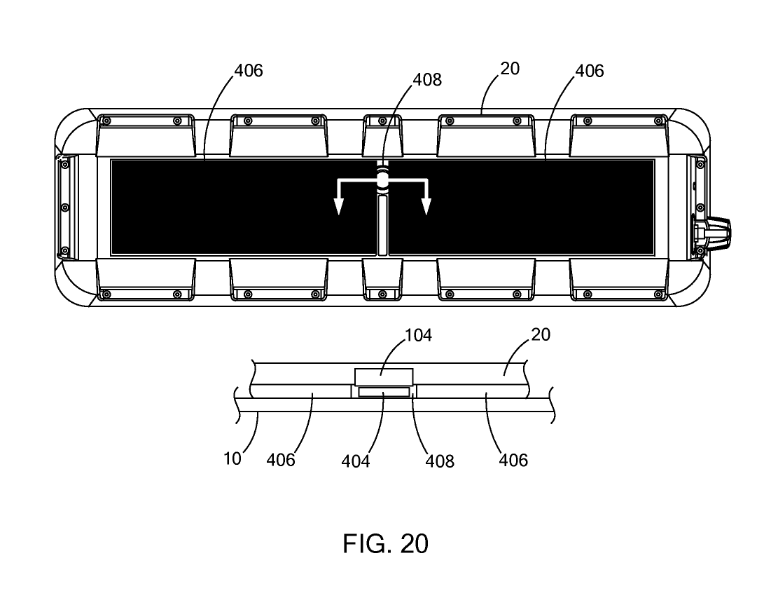

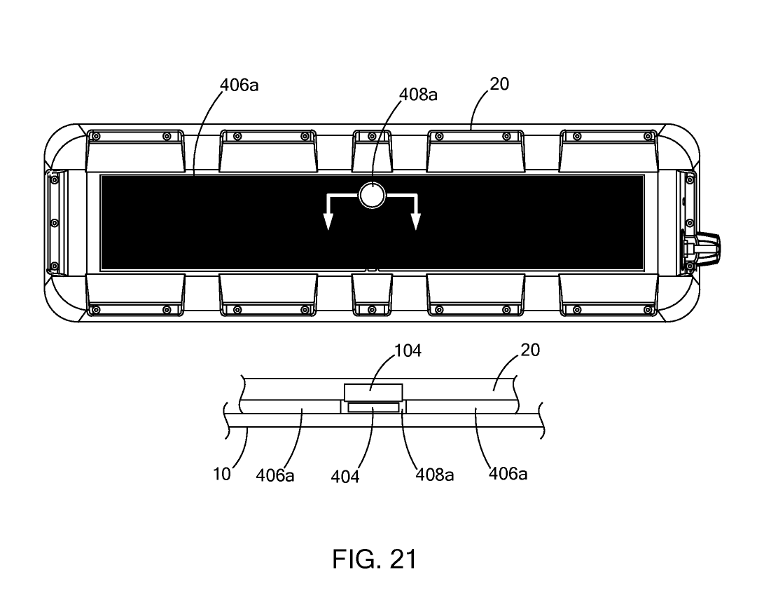

With reference to FIGS. 20 and 21, the tamper detect sensor 104 and corresponding switching device 402 are preferably located near the midpoint of the device 20 along its length, and offset from the middle toward the edge of the device 20 along its width. Of course, other locations could also be used, if desired.

The switching device 402 is housed within the device 20 and disposed at the wall of the device 20 that is placed against the container 10 when installed, as shown in the cross-sectional views accompanying FIGS. 20 and 21. Positioning the switching device 402 near the wall of the device allows for the magnet 404, which is positioned outside the device 20, to still be positioned close to switching device 402, allowing for the magnet 404 to maintain the switching device 402 in its open state. The magnet 404 has a magnetic field that results in a relatively low magnetic force, such that even slight movement of the device 20 away from the magnet 404 will cause the switching device 402 to close.

In one approach, with reference to FIGS. 17 and 20, the device 20 is installed to the container via a pair of adhesive pads 406. In a preferred form, the pads 406 have a size of 145×50×1.6 mm. The thickness of the pads 406 are preferably greater than the thickness of the magnet 404, such that the magnet 404 can be positioned between device 20 and the container 10, with the distance between the device 20 and the container 10 being defined by the thickness of the adhesive pads. In one approach, the adhesive pads 406 are in the form of a double sided foam tape, such as VHB tape manufactured by 3M.

In one approach, the adhesive pads 406 are affixed to the device 20 on the outer surface of the device wall that is placed against the container 10 when installed. The pads 406 are arranged on the device to define a lateral gap 408 between the pads 406. The pads 406 are arranged on the device on either side of the position of the switching device 402, such that the gap 408 extends over the position of the switching device 402. The magnet 404 can then be positioned within the gap 408 without protruding beyond the thickness of the pads 406.

In another approach, shown in FIG. 21, the pads 406 could be replaced with a single pad 406a that defines a hole 408a, where the pad 406a and hole 408a are positioned on the device 20 such that the hole 408a is aligned with the switching device 402. In this approach, the magnet 404 will fit within the hole 408a in a manner similar to the positioning of the magnet 404 within the gap 408. Other approaches could also be used for the shape and arrangement of the pads 406 or pad 406a such that the magnet 404 can be placed within an opening or gap and have a profile that does not extend beyond the thickness of the pads 406 or pad 406a.

The magnet 404 is positioned on the container 10, and the device is positioned on the container 10, such that the magnet 404 and switching device 402 are generally aligned. The magnet 404 is disposed between the device 20 and the container 10, such that it is difficult to access the magnet 404 when the device 20 is installed on the container 10.

Because the magnet 404 and switching device 402 are positioned to be generally aligned, and because the magnet 404 will ultimately be covered by the device 20 when the device 20 is installed on the container 10, it can be difficult or time consuming to align the device 20 with the magnet 404 if the magnet 404 is installed separately from (e.g. prior to) installing the device 20 on the container 10. Thus, in one approach, the magnet 404 is held to the device 20 prior to installation of the device 20, and installation of the device 20 will also install the magnet 404. The magnet 404 is positioned on the device 20 such that it is generally aligned with the switching device 402, and while placing the device 20 on the container 10, the magnet 404 will maintain its general position relative to the switching device 402.

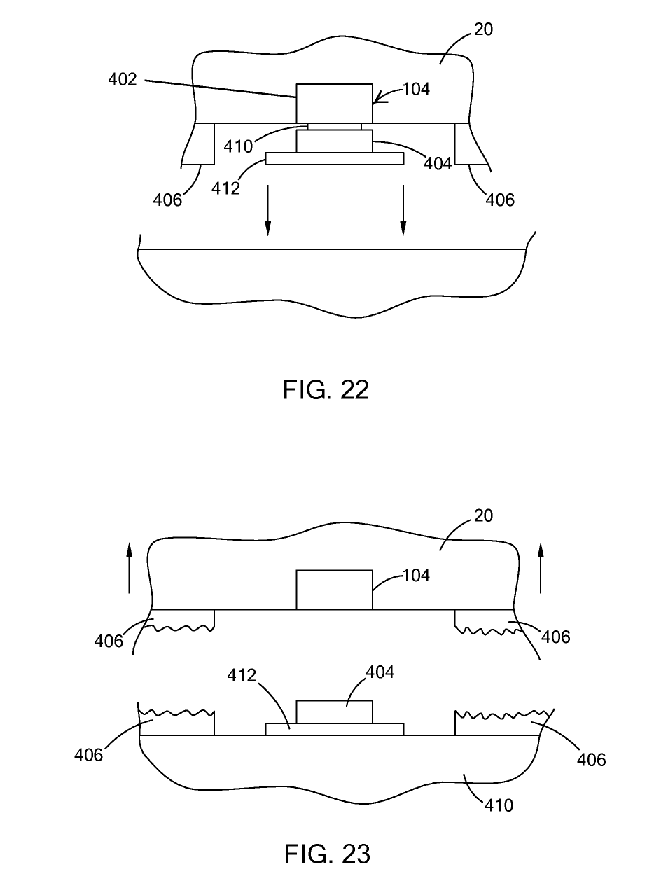

With reference to FIGS. 22 and 23, to hold the magnet 404 to the device 20, an adhesive element 410 is disposed between the magnet 404 and the device 20. The adhesive element 410 can be in the form of a tape or a glue, or the like. To hold the magnet 404 to the container 10 after installation of the device 20, the magnet 404 can include a second adhesive element 412 on its outermost surface relative to the device (innermost surface relative to the container 10 when installed). The second adhesive element can be in the form of a tape or a glue, or the like. The first adhesive element 410 is sized to provide the desired distance between the magnet 404 and the switching device 402. The magnet 404 is also (or alternatively) held to the container 10 via its magnetic qualities and the ferrous nature of the container wall where the device 20 is installed. In the event the container wall is made of a material that is not magnetically responsive to the magnet 404, the second adhesive can still hold the magnet 404.

FIG. 23 illustrates the device 20 having been pulled away from the container 10, with the magnet 404 being retained on the container 10. The adhesive strength of the second adhesive element 412 is greater than the adhesive strength of the first adhesive element 410, such that removing the device 20 from the container 10 will not remove the magnet 404. The adhesive strength of the second adhesive element 412 will maintain the magnet on the container 10. Additionally, the magnetic strength of the magnet 404 will help hold the magnet 404 to the container 10 when the container surface is such that it will respond to the magnetic qualities of the magnet 404.

Of course, it will be appreciated that the magnet 404 could be installed separately from the device 20, and the device 20 could be aligned during installation, if necessary or desired. In this way, use of the first adhesive element 410 can be eliminated.

In a preferred approach, the pads 406 and second adhesive element 412 include peel away covering that protects the outer adhesive surfaces until the time of installation. For installation, the coverings are removed, exposing the adhesive surfaces.

The above description of the sensor 104 has described the magnet 404 acting on the switching device 402. However, in another approach, the sensor 104 could operate without the use of the magnet 404. In this alternative approach, the switching device 402 could include a magnet (not shown), and the magnetic switching device 402 could act on the container wall if the container wall is such that it will respond to the magnetic forces of this alternative switching device 402. That is, the moveable element 403 can be formed of a magnetic material generating a magnetic field, or have a magnet attached to it, which is attractive to the container wall which is typically formed of a metal material. When the device 20 is moved away from the container wall, the spring 405 would overcome the attraction of the moveable element 403 towards the container wall to close the electrical circuit.

Operation of the tamper detect sensor 104 operates in addition to the power management operation described previously, which will not be described again in detail. Accordingly, the operation of the tamper detect sensor 104 is as follows.

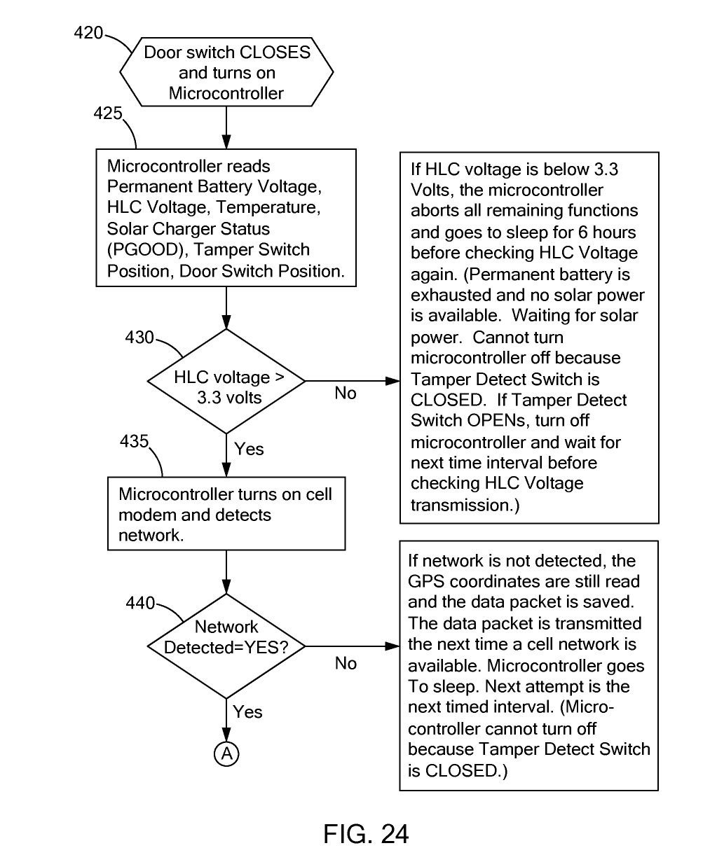

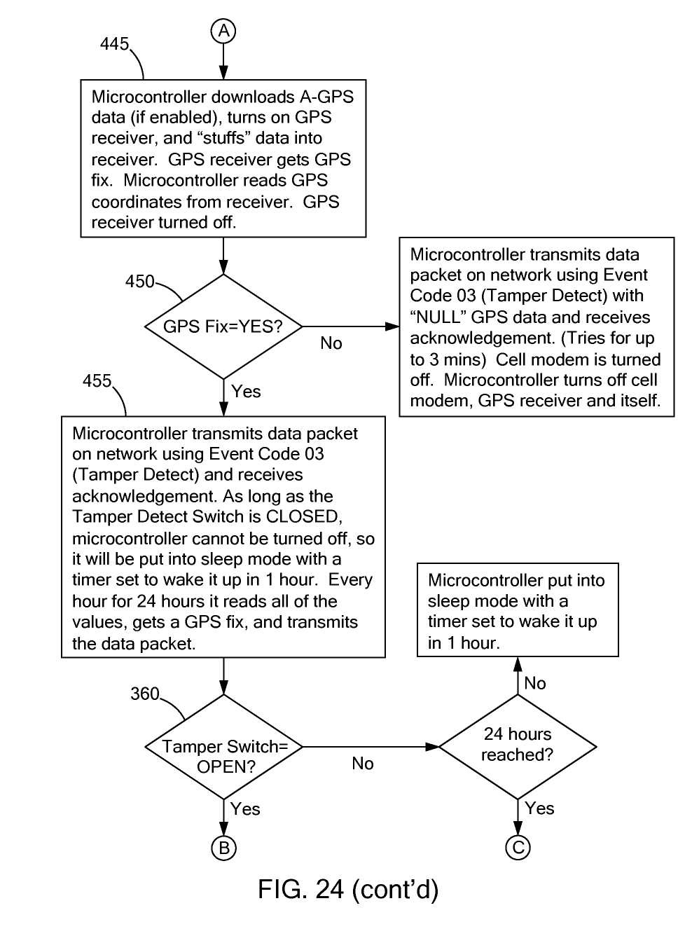

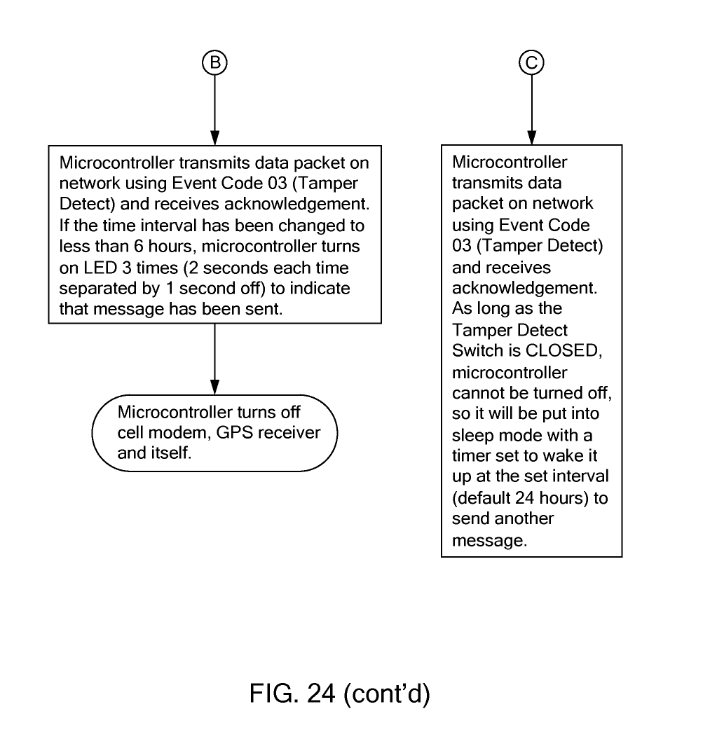

With reference to the method shown in FIG. 24, upon detection at step 420 that the switching device 402 has closed, meaning that the device 20 has been pulled away from the container and the magnet 404 (which remains attached to the container), the microcontroller 36 is turned on if it was not already turned on.

At step 425, the microcontroller 36 reads the permanent battery voltage, the HLC voltage, the temperature, the solar charger status (PGOOD), and the switching device 402 position (in this case the switching device 402 is closed). The microcontroller 36 will also read the status of other sensors or switches that may be installed, such as the door open sensor 106.

At step 430, the voltage level of the HLC 142 will be evaluated. If the voltage is equal to or lower than 3.3 volts, the microcontroller 36 will abort all remaining functions and sleep for 6 hours (or other predetermined time) before checking the HLC voltage again. The HLC voltage may be low for various reasons. The permanent battery may be drained and no solar power (or other external power) is available to charge the HLC. Thus, the microcontroller 36 will wait for 6 hours in the event that solar charging becomes available. The microcontroller 36 will sleep instead of turning off because the switching device 402 is in the closed position. If the switching device 402 opens, the microcontroller 36 will turn off, and will wait until the next predetermined time interval to turn back on and check HLC voltage. However, this setting is configurable, and the microcontroller 36 can remain in a sleep mode even after the switching device 402 opens.

If the voltage level of the HLC determined at step 430 is greater than 3.3 volts, the microcontroller 36 will turn on the cell modem and detect a cellular network at step 435. At step 440, the microcontroller 36 will determine if a network is detected. If not, the GPS coordinates are still read and the data packet is saved. The data packet will be sent the next time a cell network is available. Alternatively or additively, the microcontroller 36 may also check if other communications networks, such as LAN, are available to send the indication. The microcontroller 36 will sleep, and the next attempt will occur at the next predetermined time interval. The microcontroller 36 will not turn off because the switching device 402 is closed, so the microcontroller 36 will sleep.

If a network is detected at step 440, at step 445, the microcontroller 36 downloads A-GPS data (if enabled), turns on the GPS receiver, and stuffs data into the GPS receiver. The GPS receiver attempts to get a GPS fix, and will try for up to 3 minutes to do so. The microcontroller 36 will read the GPS coordinates from the receiver, and the GPS receiver will then turn off.

At step 450, the microcontroller 36 will determine whether it has a GPS fix. If not, the microcontroller 36 will transmit the data packet on the network with an event code corresponding to the switching device 402 being closed (device 20 has moved away from the magnet 404 and the container 10) along with NULL GPS data and will attempt to receive acknowledgment for up to 3 minutes. That is, the tamper detect is reported without GPS data. Alternatively, the microcontroller 36 can further attempt to determine location based on LAN address, cell tower location, or the like, and transmit this alternative location information. The microcontroller 36 will then turn off the cell modem, the GPS receiver, and itself.

If the microcontroller 36 does has a GPS fix as determined at step 450 (or the location is determined using other networks), then at step 455 the microcontroller 36 will transmit the data packet, including the event code for the switching device 402 being closed and will receive acknowledgement. Because the switching device 402 is closed, the microcontroller 36 will sleep. It will be set to wake in 1 hour, and every 24 hours, it will read all of the values, get a GPS fix, and transmit the data packet.

At step 460, the microcontroller 36 will determine if the door switching device 402 is open (i.e. installed on the container). If not, it will determine if 24 hours have been reached. If 24 hours have not been reached, the microcontroller 36 will sleep and be set to wake in 1 hour. Once 24 hours have been reached data packets will continue to be sent based on a predetermined time interval, such as every 24 hours, while the door switching device 402 remains closed (the device 20 has been moved away from the magnet 404 and the container 10). If, at step 460, it is determined that the switching device 402 is open, meaning that the device 20 has moved back to its installed position over the magnet 404 causing the magnet 404 to counteract the bias in the switching device 402 to move it back to the open position, then the microcontroller 36 will transmit the data packet and receive acknowledgment and then turn off the cell modem, the GPS receiver, and itself.

The above described process for communicating the detection of the switching device 402 being closed is one example. It will be appreciated that variations can be made to the above device to save instances of the switching device 402 being closed and communicating them at various intervals depending on other detected conditions, such as by varying the predetermined time periods, using other means for identifying location such as LAN identity or cell tower identity, or the like.

The above described device 20 having the tamper detect sensor 104 is particularly beneficial as it does not draw power while the device 20 remains installed over the magnet 404, which preserves power, and will not check for tamper detected states until such time as the device 20 is moved away from the magnet 404, which also preserves power. The device 20 is also particularly suited to easy installation on existing containers 10, allowing for containers 10 that are already in service to be retrofitted with the device 20 to realize the advantages of the device 20 and tamper detect sensor 104 without substantial modifications. For example, the magnet 404 and device 20 can be installed to the container 10 without requiring electrical wiring or modification (though the device 20 may be attached to an external power source if desired). The magnet 404 is adhesively and magnetically attached without electrical attachments.

Through the foregoing arrangements, it will be recognized that a tracking system is provided that achieves new levels of useful life through and adaptable power supply and unique construction. The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A tracking device for tracking the location of a container, the container having a surface on which to mount the tracking device, the tracking device comprising:
a housing for mounting to the container, the housing containing a communication system and a power system, the communication system for identifying the location of the container and communicating the location, the power system for supplying power to the communication system;
a switching device connected to the housing for movement therewith, the switching device electrically connected to the communication system in a circuit, the switching device operable between a closed state closing the circuit and an open state opening the circuit, the switching device normally being in the open state;
a first magnetically reactive element forming part of the switching device and moving to operate the switching device between the open state and the closed state, the first magnetically reactive element biased to one of the open state and the closed state; and
a second magnetically reactive element for mounting to the container at a position spaced a predetermined distance from the first magnetically reactive element, one of the first and second magnetically reactive elements generating a magnetic field the induces a magnetic force on the first magnetically reactive element in opposition to the bias;
whereby movement of the housing relative to the container changes the position of the first magnetically reactive element relative to the second magnetically reactive element to vary the magnetic force and cause the first magnetically reactive element to move and operate the switching device to the closed state.

2. The device of claim 1 wherein one of the first and second magnetically reactive elements is a permanent magnet generating the magnetic field.

3. The device of claim 2, wherein the magnetic force provided by the magnet remains constant, and the received magnetic force only changes in response to the housing being moved.

4. The device of claim 1, wherein the housing includes a bottom wall and a top wall, and the switching device is arranged within the housing and adjacent the bottom wall.

5. The device of claim 4 further comprising at least one adhesive pad attached to an outer surface of the bottom wall for mounting the housing to the container.

6. The device of claim 5, wherein the at least one adhesive pad defines a recess.

7. The device of claim 6, wherein the recess has a height and a width, and the second magnetically reactive element has a height and width that are both smaller than the height and width of the recess.

8. The device of claim 1, wherein the second magnetically reactive element is a magnet initially attached to the device via a first adhesive element disposed therebetween.

9. The device of claim 8 further comprising a second adhesive element extending over the magnet, wherein the magnet is disposed between the first adhesive element and the second adhesive element.

10. A method for detecting movement of a tracking device on a container, the method comprising:
providing a tracking device comprising a housing having a bottom wall, the housing containing a switching device mounted to the housing for movement therewith, the switching device electrically connected to a powered communication system, the switching device being in a normally open state, the switching device including a biasing element biasing a magnetically reactive element to a closed state, and a magnet releasably attached to the an external surface of the bottom wall of the tracking device, the magnet being positioned over the switching device to induce a magnetic force on the magnetically reactive element that counteracts the biasing element and keeps the switching device in the open state;
attaching the tracking device to the container with the bottom wall against a surface of the container;
attaching the magnet to the surface of the container such that, upon movement of the tracking device away from the surface of the container, the position of the magnet on the surface of the container is maintained; and
switching the switching device to the closed position via the biasing element when the bottom wall is moved away from the surface of the container and the magnetic force of the magnetically reactive element is reduced.

11. The method of claim 10, wherein the tracking device includes at least one adhesive pad attached to the exterior surface of the bottom wall of the tracking device.

12. The method of claim 11, wherein the at least one adhesive pad defines a recess, and the magnet is disposed within the recess and does not protrude beyond the adhesive pad.

13. The method of claim 10, wherein the magnet is attached to the tracking device by a first adhesive element disposed therebetween.

14. The method of claim 13 further comprising a second adhesive element covering the magnet, wherein the magnet is disposed between the first adhesive element and the second adhesive element.

15. The method of claim 14, wherein the adhesive strength of the adhesive element is weaker than the adhesive strength of the second adhesive element.

16. The method of claim 15, wherein the adhesive element between the magnet and the tracking device is overcome by moving the bottom wall of the tracking device away from the container, and the second adhesive element maintains the magnet on the container in response to the tracking device moving away from the container.

17. The method of claim 10, wherein the magnet is completely covered by the tracking device when the tracking device is attached to the container.

18. The method of claim 10, wherein the switching device is in communication with a microcontroller powered by a power supply, the microcontroller operating the communication system of the tracking device for identifying the location of the container and communicating the location, and further comprising:
turning on the microcontroller in response to detecting the closed position of the switch device;
evaluating, via the microcontroller, that a voltage in a power supply of the tracking device is above a predetermined level; and
when the voltage is above the predetermined level, transmitting a data packet over a wireless network, the data packet including an event code related to the switching device being in the closed state.

19. The method of claim 18, further comprising turning on a wireless modem and detecting a wireless network when the voltage is above the predetermined level.

20. The method of claim 18, further comprising putting the microcontroller in a sleep mode in response to failing to detect a wireless network or that a voltage in a power supply of the tracking device is below the predetermined level.
